(19) United States
(12) Patent Application Publication
(10) Pub. No.: US 2022/0193614 A1
(43) Pub. Date: Jun. 23, 2022

(54) VENTING OR DEGASSING OF FILTER DEVICES AND FILTRATION SYSTEMS

(71) Applicant: Repligen Corporation, Waltham, MA (US)

(72) Inventors: Bao Le, Redondo Beach, CA (US); Philip Yuen, Long Beach, CA (US)

(73) Assignee: Repligen Corporation, Waltham, MA (US)

(21) Appl. No.: 17/559,792

(22) Filed: Dec. 22, 2021

Related U.S. Application Data
(60) Provisional application No. 63/129,988, filed on Dec. 23, 2020.

(51) Int. Cl. B01D 63/02; B01D 19/00

(52) U.S. Cl. CPC B01D 63/02; B01D 2313/16; B01D 2313/21; B01D 19/0031

(57) ABSTRACT

Devices, systems, and methods for continually degassing/venting a feedstream within a filtration system. The filtration system may include a filter device utilizing hollow fiber filters to filter the feedstream. Additional venting hollow fiber filters vent gas from the filtration system to outside the filtration system. The venting hollow fiber filters may have ends which expose the interior lumens thereof to outside the filter unit to vent gases which pass through the walls of the hollow fiber filters. Degassed permeate thus flows through the filtering hollow fiber filters.

### CROSS-REFERENCE TO RELATED APPLICATIONS

This application is a continuation of and claims the benefit of priority under 35 U.S.C. § 119 to U.S. Provisional Patent Application No. 63/129,988, filed Dec. 23, 2020, the disclosure of which is incorporated herein by reference in its entirety for all purposes.

### FIELD OF THE DISCLOSURE

The present disclosure relates generally to process filtration systems, and more particularly to venting or degassing such systems and filter devices thereof. Principles of the present disclosure are particularly suitable for dead-end filtration systems, such as those utilizing hollow fiber filters.

### BACKGROUND

Filtration is typically performed to separate, clarify, modify, and/or concentrate a fluid solution, mixture, or suspension. In the biotechnology and pharmaceutical industries, filtration is vital for the successful production, processing, and testing of new drugs, diagnostics, and other biological products. For example, in the process of manufacturing biologicals, using animal or microbial cell culture, filtration may be performed for clarification, selective removal and concentration of certain constituents from the culture media, and/or to modify the media prior to further processing. Filtration may also be used to enhance productivity by maintaining a culture in perfusion at high cell concentration.

Tangential flow filtration (also referred to as TFF or cross-flow filtration) systems are widely used for the separation of particulates suspended in a liquid phase, and have important bioprocessing applications. In contrast with dead-end filtration systems, in which a single fluid feed is passed through a filter (generally, single pass filtration in a single flow direction, leaving retentate dead-ended on the upstream side of the filter, and permeate on the downstream side of the filter), tangential flow systems are characterized by feed that flows over the filter in a direction generally along or tangent to the surface of the filter, where components of the feed can pass through the membrane into the filtrate. This results in the separation of the feed into two components: a permeate component (which has passed through the filter), and a retentate component (which has not passed through the filter). Compared to dead-end filtration, the retentate in TFF systems is washed away during the filtration process, minimizing membrane fouling. Thus, compared to dead-end systems, TFF systems are less prone to fouling. Fouling of TFF systems may be reduced further by alternating the direction of the fluid feed across the filtration element as is done in the XCell™ alternating tangential flow (ATF) technology commercialized by Repligen Corporation (Waltham, Mass.), by backwashing the permeate through the filter, and/or by periodic washing.

Modern TFF systems frequently utilize filters comprising one or more tubular filtration elements, such as hollow-fibers or tubular membranes. Where tubular filtration elements are used, they are typically packed together within a larger fluid vessel (e.g., the filtration elements are packed within a filter housing or chamber or vessel to form a filter unit or module or capsule), and are placed in fluid communication with a feedstream or fluid at an upstream end, and with a vessel or fluid path for the retentate at the downstream end. The feedstream or fluid flows into the tubular filtration elements, with smaller materials passing through pores in the walls of the tubular filtration elements, and flowing as permeate into the extracapillary spaces outside and between the fibers within the filter housing. Tubular filtration elements provide large and uniform surface areas relative to the feed stream volumes they can accommodate, and TFF systems utilizing these elements may be scaled easily from development to commercial scale. Despite their advantages, TFF systems filters may foul when filter flux limits are exceeded, and TFF systems have finite process capacities. Efforts to increase process capacities for TFF systems are complicated by the relationship between filter flux and fouling. Moreover, microbubbles of gases may build up within the filters and create air locks if not adequately vented or released from the system. Traditional filter devices and filtration systems pass gases from the feed stream by diverting gases through a separate hydrophobic filter material. The gases ultimately are reintroduced into the retentate stream as the outlet of the hydrophobic filter material runs in the same direction of the other filtration material. This prevents air locking by allowing gases to bypass the primary filtration material through the hydrophobic filter material. However, the gases will remain in the retentate stream.

### SUMMARY

This summary of the disclosure is given to aid understanding, and one of skill in the art will understand that each of the various aspects and features of the disclosure may advantageously be used separately in some instances, or in combination with other aspects and features of the disclosure in other instances. No limitation as to the scope of the claimed subject matter is intended by either the inclusion or non-inclusion of elements, components, or the like in this summary.

In an aspect, this disclosure describes a device. This device may comprise a hollow fiber filter housing comprising an inlet and an outlet fluidly sealed from the inlet, a first hollow fiber loop disposed within the filter housing, the first hollow fiber loop comprising first and second ends fluidly communicating with the outlet and a liquid permeable side wall extending between the first and second ends such that an exterior surface of the liquid permeable side wall fluidly communicates with the inlet, and a second hollow fiber loop disposed within the filter housing, the second hollow fiber loop comprising first and second ends fluidly communicating with the exterior of the housing and a gas permeable sidewall extending therebetween, such that an exterior surface of the gas permeable side wall fluidly communicates with the inlet.

In some embodiments, the ends of the second hollow fiber loop may be disposed through the end cap and potting. A loop of the second hollow fiber loop may be disposed within the hollow fiber filter. The second hollow fiber loop may be polypropylene. The first and second ends of the second hollow fiber loop may be exposed to the outside of the end cap. The outlet may be potted with filtration media fibers. The inlet may be potted in the end cap in location of equal angular distance with polypropylene second hollow fiber loops extending through the end cap. The second hollow fiber loop ends may expose the polypropylene lumen inner diameter.

In an aspect, this disclosure describes a method of using a filter device. This method may comprise flowing media through an inlet of a hollow fiber filter, the filter comprising a hollow fiber filter housing, comprising an inlet, and an outlet fluidly sealed from the inlet, a first hollow fiber loop disposed within the filter housing, the first hollow fiber loop comprising first and second ends fluidly communicating with the outlet and a liquid permeable side wall extending between the first and second ends such that an exterior surface of the liquid permeable side wall fluidly communicates with the inlet, a second hollow fiber loop disposed within the filter housing, the second hollow fiber loop comprising first and second ends fluidly communicating with the exterior of the housing and a gas permeable sidewall extending therebetween, such that an exterior surface of the gas permeable side wall fluidly communicates with the inlet, and removing media through the outlet.

In some embodiments, the second hollow fiber loops may be polypropylene. The hollow fiber loops may continuously vent the filter by allowing air to escape out of the filter housing.

In an aspect, this disclosure describes a filter device having a housing with an inlet chamber defined at an inlet end of the housing, and an outlet chamber defined at an outlet end of the housing and fluidly sealed from the inlet chamber. The housing also includes at least one liquid permeable hollow fiber filter disposed within the filter housing, the liquid permeable hollow fiber filter having a liquid permeable wall defining a lumen extending through the liquid permeable hollow fiber filter and defining an intracapillary space in fluid communication with the outlet chamber, the exterior surface of the liquid permeable side wall being in fluid communicates with the inlet chamber via extracapillary space defined within the interior of the housing. At least one gas permeable hollow fiber filter is disposed within the filter housing, the gas permeable hollow fiber filter having a gas permeable sidewall defining a lumen extending through the gas permeable hollow fiber filter and defining an intracapillary space in fluid communication with the exterior of the housing to vent gases to outside the filter device, the exterior surface of the gas permeable side wall being in fluid communication with the inlet chamber via the extracapillary spaced defined by the interior of the housing.

In some embodiments, the device includes an inlet end cap coupled to the inlet end of the housing and defining the inlet chamber therein; and an outlet end cap coupled to the outlet end of the housing and defining the outlet chamber therein; where the gas permeable hollow fiber filter has at least one open end extending through one of the end caps to be in fluid communication with the exterior of the end cap. In some embodiments, the gas permeable hollow fiber filter is in the form of a loop with a closed end and two open ends, the closed end being disposed within the housing and the open ends being in fluid communication with the exterior of the housing. In some embodiments, the liquid permeable hollow fiber filter is in the form of a loop with a closed end and two open ends, the two open ends being potted in the outlet end cap. In some embodiments, the liquid permeable hollow fiber filter is in the form of a loop with a closed end and two open ends, the two open ends being potted in the outlet end cap.

In some embodiments, the gas permeable hollow fiber filter is formed of polypropylene.

In some embodiments, the at least one gas permeable hollow fiber filter extends from the inlet end of the housing to the outlet end of the housing. In some embodiments, the at least one liquid permeable hollow fiber filter has an end in fluid communication with the outlet chamber and sealed from the interior of the housing.

In an aspect, this disclosure describes a filter device with a housing defining an interior therein; a liquid permeable hollow fiber filter having a wall with an exterior in fluid communication with the interior of the housing and defining a lumen within the liquid permeable hollow fiber filter in fluid communication with an outlet chamber fluidly sealed from the housing interior; and a gas permeable hollow fiber filter with a wall having an exterior in fluid communication with the interior of the housing and defining a lumen within the gas permeable hollow fiber filter venting to outside the housing to release gas passing through the wall of the gas permeable hollow fiber filter from the interior of the housing to the lumen within the gas permeable hollow fiber filter.

In some embodiments, the device includes an inlet end cap coupled to an inlet end of the housing and defining an inlet chamber therein; and an outlet end cap coupled to an outlet end of the housing and defining an outlet chamber therein; where the gas permeable hollow fiber filter has at least one open end extending through one of the end caps to be in fluid communication with the exterior of the end cap. In some embodiments, the gas permeable hollow fiber filter is in the form of a loop with a closed end and two open ends, the closed end being disposed within the housing and the open ends being in fluid communication with the exterior of the housing. In some embodiments, the liquid permeable hollow fiber filter is in the form of a loop with a closed end and two open ends, the two open ends being potted in the outlet end cap. In some embodiments, the liquid permeable hollow fiber filter is in the form of a loop with a closed end and two open ends, the two open ends being potted int the outlet end cap.

In some embodiments, the at least one gas permeable hollow fiber filter extends substantially along the entire length of the at least one liquid permeable hollow fiber filter.

In an aspect, the present disclosure describes a method of venting a filtration system, the method includes passing a feedstream through an inlet of a filter device and into the interior of the housing of the filter device; and allowing the feedstream to filter through the wall of a liquid permeable hollow fiber filter within the filter housing from the exterior surface of the wall of the liquid permeable hollow fiber filter and into a lumen defined within the liquid permeable hollow fiber filter; passing gas from the interior of the filter housing through the wall of a gas permeable hollow fiber filter disposed within the filter housing, from the exterior surface of the gas permeable hollow filter fiber wall and into a lumen defined within the gas permeable hollow fiber filter; and venting gas from within the gas permeable hollow fiber filter lumen to be expelled out an open end of the gas permeable hollow fiber filter communicating with the exterior of the housing.

In some embodiments, the method includes allowing the gas permeable hollow fiber filter to continuously vent the filter device by allowing gas to escape out of the filter housing.

In some embodiments, the method includes collecting the permeate within the liquid permeable hollow fiber filter lumen through an outlet of the filter device.

These and other features and advantages of the present disclosure, will be readily apparent from the following detailed description, the scope of the claimed invention being set out in the appended claims. While the following disclosure is presented in terms of aspects or embodiments, it should be appreciated that individual aspects can be claimed separately or in combination with aspects and features of that embodiment or any other embodiment.

### BRIEF DESCRIPTION OF THE DRAWINGS

Non-limiting embodiments of the present disclosure are described by way of example with reference to the accompanying drawings, which are schematic and not intended to be drawn to scale. The accompanying drawings are provided for purposes of illustration only, and the dimensions, positions, order, and relative sizes reflected in the figures in the drawings may vary. In the figures, identical or nearly identical or equivalent elements are typically represented by the same reference characters, with redundant description omitted. For purposes of clarity and simplicity, not every element is labeled in every figure, nor is every element of each embodiment shown where illustration is not necessary to allow those of ordinary skill in the art to understand the disclosure.

The above and other aspects of the present disclosure will be more apparent from the following detailed description, presented in conjunction with the following drawings wherein:

FIG. 1 illustrates an elevational view of an example of an embodiment of a hollow fiber filter and housing according to various principles of the present disclosure.

FIG. 2 illustrates a cross-sectional view of a hollow fiber filter and housing similar to that of FIG. 1.

FIG. 3 illustrates a perspective view of a hollow fiber filter and housing similar to that of FIG. 1 and FIG. 2, with a part of an end cap thereof illustrated in cross-section.

FIG. 4 illustrates a perspective view of a hollow fiber filter and housing similar to that of FIG. 3.

FIG. 5 illustrates an elevational view of an alternate embodiment of a hollow fiber filter and housing according to various principles of the present disclosure.

### DETAILED DESCRIPTION

The following detailed description should be read with reference to the drawings, which depict illustrative embodiments. It is to be understood that the disclosure is not limited to the particular embodiments described, as such may vary. All apparatuses and systems and methods discussed herein are examples of apparatuses and/or systems and/or methods implemented in accordance with one or more principles of this disclosure. Each example of an embodiment is provided by way of explanation and is not the only way to implement these principles but are merely examples. Thus, references to elements or structures or features in the drawings must be appreciated as references to examples of embodiments of the disclosure, and should not be understood as limiting the disclosure to the specific elements, structures, or features illustrated. Other examples of manners of implementing the disclosed principles will occur to a person of ordinary skill in the art upon reading this disclosure. In fact, it will be apparent to those skilled in the art that various modifications and variations can be made in the present disclosure without departing from the scope or spirit of the present subject matter. For instance, features illustrated or described as part of one embodiment can be used with another embodiment to yield a still further embodiment. Thus, it is intended that the present subject matter covers such modifications and variations as come within the scope of the appended claims and their equivalents.

It will be appreciated that the present disclosure is set forth in various levels of detail in this application. In certain instances, details that are not necessary for one of ordinary skill in the art to understand the disclosure, or that render other details difficult to perceive may have been omitted. The terminology used herein is for the purpose of describing particular embodiments only, and is not intended to be limiting beyond the scope of the appended claims. Unless defined otherwise, technical terms used herein are to be understood as commonly understood by one of ordinary skill in the art to which the disclosure belongs. All of the devices and/or methods disclosed and claimed herein can be made and executed without undue experimentation in light of the present disclosure.

Bioprocessing systems designed to harvest a biological product at the conclusion of a cell culture period generally utilize a large-scale separation device such as a depth filter or a centrifuge in order to remove cultured cells from a fluid (e.g., a culture medium) containing the desired biological product. These large scale devices are chosen in order to capture large quantities of particulate material, including aggregated cells, cellular debris, etc. However, the trend in recent years has been to utilize disposable or single-use equipment in bioprocessing suites to reduce the risks of contamination or damage that may accompany sterilization of equipment between operations, and the costs of replacing large scale separation devices after each use would be prohibitive.

Additionally, industry trends indicate that durations of bioprocessing operations are being extended or even made continuous. Such operations may extend into days, weeks, or months of operation. Many typical components, such as filters, are unable to adequately perform for such lengths of time without fouling or otherwise needing maintenance or replacement.

Additionally, in bioprocessing it is often desirable to increase process yields by increasing cell density. However, increasing cell density may be complicated by increased filter fouling, etc.

Hollow fiber filters address these challenges by providing economical filtration means that are tolerant of increased cell densities and extended process times, and are suitable for use in harvest. Tangential flow depth filters made by melt blowing of polymers or polymer blends can be manufactured at a comparatively low-cost compatible with single use, yet are able to operate for extended periods, at high fluxes, and at increased cell densities. Yet even with these improvements, problems may arise. One such issue is the buildup of microbubbles within the filters. Typically, an aqueous in-line filter/degasser works upon initial set-up and priming of the lines. But as bubbles build up during use, the bubbles can cause the filters to air lock without a manual release or venting of the air pocket.

Filter devices, filtration systems, and filtration methods in accordance with various principles of the present disclosure release gas, such as air, external to the device or system to vent or to degas the system and thereby to reduce, and preferably eliminate, airlocking of filter elements thereof. The filter device has an inlet through which a feedstream or fluid (such terms being used interchangeably herein without intent to limit) enters the filter device for filtration therein by the filters (e.g., filter elements such as hollow fiber filters) therein. The filter device also has an outlet through which the retentate flows for further processing, etc. The embodiments of the present disclosure describe a degasser/venting device and system that includes at least one, and preferably a plurality of gas permeable degassing/venting elements, such as hollow fiber filters with an inner lumen, exposed to the exterior of the filter device housing to release/vent gases from within the filtration system to outside the filtration system. It will be appreciated that terms such as degassing or venting (and other grammatical forms thereof, such as degasser, vent, ventilation, etc.) may be used interchangeably herein without intent to limit. As referenced herein, gas or gases are to be understood as including, but not necessarily limited to, air, oxygen, carbon dioxide, nitrogen, etc. Moreover, it will be appreciated that terms such filter device, filter unit, filter module, filter, etc., may be used interchangeably herein without intent to limit. The gas permeable hollow fibers may be a coil or loop of hollow fibers with exposed open ends. The present disclosure describes various devices, systems and methods wherein gas permeable hollow fiber filters enclosed within the hollow fiber filter module or capsule are exposed to the exterior of the filter device housing, allowing for the flow of gases out of the filter device housing during use. Gas that is carried through a fluid that enters the filter device housing (through the filter device inlet) passes through the walls of the plurality of gas-permeable hollow fiber filters and into the respective interior lumens thereof, while the fluid passes through walls of a plurality of liquid permeable hollow fiber filters having inner lumens fluidly connected to the filter device outlet. Once the gas passes into the lumens of the gas permeable hollow fibers, the gas leaves the housing through openings in the housing which are in fluid communication with the intracapillary spaces defined by the lumens within the gas permeable hollow fiber filters. This continuous release simplifies the process over the previous degassers, which require manual release of gas or air pockets.

Various embodiments of venting devices, systems, and methods will now be described with reference to examples illustrated in the accompanying drawings. Reference in this specification to “one embodiment,” “an embodiment,” “some embodiments”, “other embodiments”, etc. indicates that one or more particular features, structures, and/or characteristics in accordance with principles of the present disclosure may be included in connection with the embodiment. However, such references do not necessarily mean that all embodiments include the particular features, structures, and/or characteristics, or that an embodiment includes all features, structures, and/or characteristics. Some embodiments may include one or more such features, structures, and/or characteristics, in various combinations thereof. Moreover, references to “one embodiment,” “an embodiment,” “some embodiments”, “other embodiments”, etc. in various places in the specification are not necessarily all referring to the same embodiment, nor are separate or alternative embodiments necessarily mutually exclusive of other embodiments. When particular features, structures, and/or characteristics are described in connection with one embodiment, it should be understood that such features, structures, and/or characteristics may also be used in connection with other embodiments whether or not explicitly described, unless clearly stated to the contrary. It should further be understood that such features, structures, and/or characteristics may be used or present singly or in various combinations with one another to create alternative embodiments which are considered part of the present disclosure, as it would be too cumbersome to describe all of the numerous possible combinations and subcombinations of features, structures, and/or characteristics. Moreover, various features, structures, and/or characteristics are described which may be exhibited by some embodiments and not by others. Similarly, various features, structures, and/or characteristics or requirements are described which may be features, structures, and/or characteristics or requirements for some embodiments but may not be features, structures, and/or characteristics or requirements for other embodiments. Therefore, the present disclosure is not limited to only the embodiments specifically described herein, and the examples of embodiments disclosed herein are not intended as limiting the broader aspects of the present disclosure.

Turning now to the drawings, it will be appreciated that common features are identified by common reference elements and, for the sake of brevity and convenience, and without intent to limit, the descriptions of the common features are generally not repeated. For purposes of clarity, not all components having the same reference number are numbered. Moreover, a group of similar elements may be indicated by a number and letter, and reference may be made generally to one or such elements or such elements as a group by the number alone (without including the letters associated with each similar element). It will be appreciated that, in the following description, elements or components similar among the various illustrated embodiments with reference numbers greater than 1000 are generally designated with the same reference numbers increased by a multiple of 1000 and redundant description is generally omitted for the sake of brevity. Moreover, certain features in one embodiment may be used across different embodiments and are not necessarily individually labeled when appearing in different embodiments.

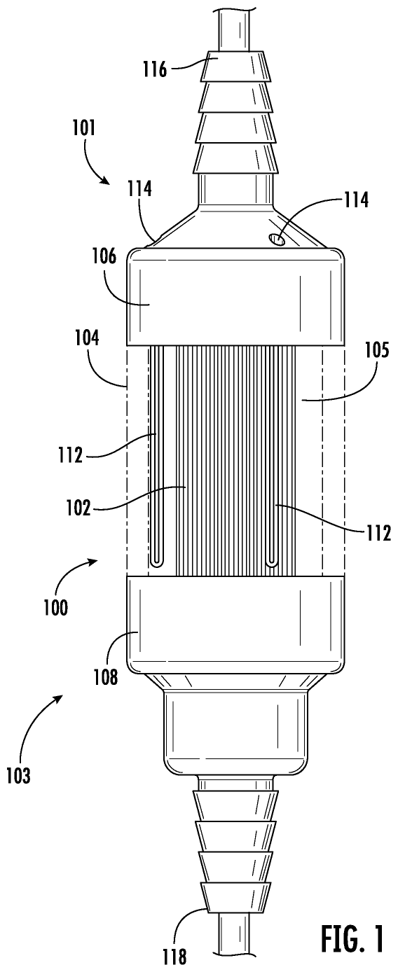

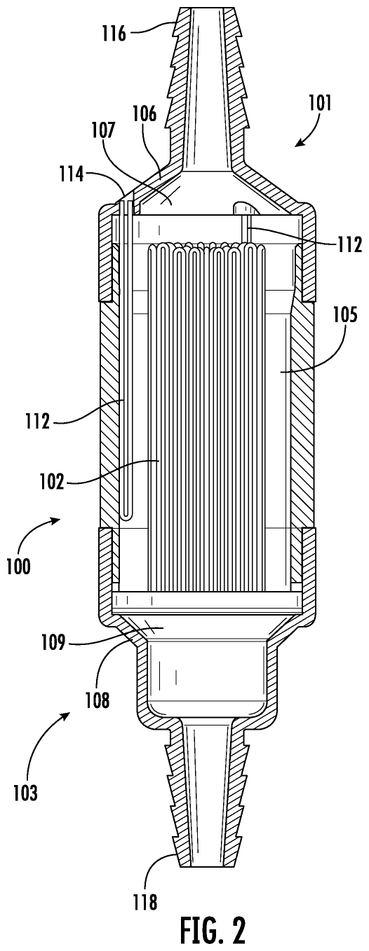

An illustration of a filter device 100 formed in accordance with various principles of the present disclosure is shown in FIGS. 1-4. The filter device 100 includes a bundle of (optionally parallel) hollow fiber filters 102 extending within a filter housing 104 between an inlet end 101 and an outlet end 103 and within a filter housing interior 105. It will be appreciated that the term housing may be used interchangeably herein with terms such as chamber, vessel, etc., without intent to limit. The filter device 100 includes an inlet end cap 106 along the inlet end 101 and defining an inlet chamber 107 therein (see FIG. 2), and an outlet end cap 108 along the outlet end 103 and defining an outlet chamber 109 therein (see FIG. 2). The end caps 106, 108 may be formed and bonded to ends of the filter housing 104 in manners known to those of ordinary skill in the art, the present disclosure not being limited in this manner. The end caps 106, 108 and hollow fiber filters 102 may be assembled such that the outlet chamber 109 is fluidly sealed from the filter housing interior 105 and the inlet chamber 107. The assembly of hollow fiber filters 102, filter housing 104, and end caps 106, 108 may be considered or referenced alternatively as a filter device, unit, module, capsule, etc., without intent to limit.

In accordance with various principles of the present disclosure, the filtering hollow fiber filters 102 used for filtration performed by the filter device 100 are formed of liquid permeable and/or hydrophobic filter materials (e.g., polyethersulfone, mixed ester (ME), etc.) configured to allow the feedstream or fluid (such terms being used interchangeably herein without intent to limit) to pass therethrough. Additionally, a filter device 100 formed in accordance with various principles of the present disclosure also includes a plurality of hollow fiber filters 112 configured to vent or degas the filtration system in which the filter device 100 is provided by venting gas bubbles from within the filter device 100 to outside the filter device 100 and, preferably, the filtration system in general. Such hollow fiber filters 112 generally are formed of gas permeable, hydrophobic filter materials (e.g., polypropylene, etc.) configured to allow free passage of gases therethrough without allowing the fluid of the feedstream to flow therethrough. For the sake of convenience, and without intent to limit, the hollow fiber filters 102 used for filtration are referenced herein as liquid permeable hollow fiber filters 102 and the venting hollow fiber filters 112 used for degassing/venting are referenced herein as gas permeable hollow fiber filters 112. In some embodiments, the liquid permeable hollow fiber filters 102 are used for sterilization/sterile filtration purposes, and may have pore sizes of approximately 0.2 μm such as to filter out bacteria, fungi, yeast, etc., although other uses are within the scope and spirit of the present disclosure.

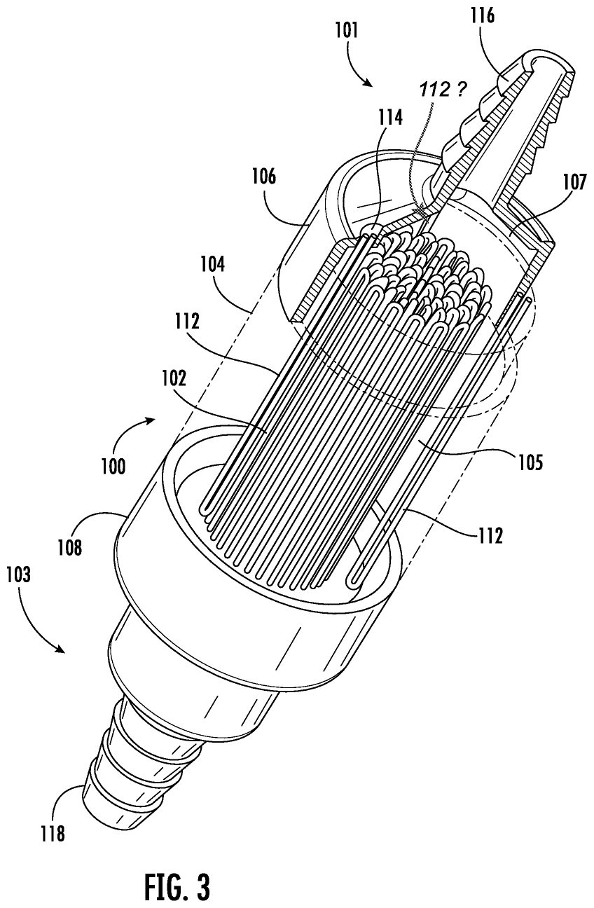

The liquid permeable hollow fiber filters 102 may be formed as loops of hollow fiber filters. Closed ends of the liquid permeable hollow fiber filters 102 are positioned adjacent the inlet end cap 106, as may be appreciated with reference to FIG. 2 and FIG. 3. The opposite ends of the liquid permeable hollow fiber filters 102 may be cut open to expose the lumens therein to the outlet chamber 109 within the outlet end cap 108. The open ends of the liquid permeable hollow fiber filters 102 may be potted (e.g., with urethane, polyurethane, epoxy, wax, glue, etc., such as known in the art) within the outlet end cap 108, as may be appreciated with reference to FIG. 2 and FIG. 3, to allow the permeate which flows through the walls of the liquid permeable hollow fiber filters 102 and into the intracapillary space defined by the inner lumen of the hollow fiber filters 102 to flow into the outlet chamber 109.

As may be appreciated with reference to FIG. 2 and FIG. 3, a fluid inlet port 116, in fluid communication with the inlet end cap 106 on the inlet end 101 of the filter housing 104 of the filter device 100, allows a feedstream to flow into the inlet chamber 107 within the inlet end cap 106 and into the extracapillary space defined by the filter housing interior 105 within the filter housing 104 (and outside the liquid permeable hollow fiber filters 102). The liquid permeable hollow fiber filters 102 within the filter housing 104 receive the feedstream flow within the filter housing interior 105 (from the inlet chamber 107). The feedstream flows through the walls of the liquid permeable hollow fiber filters 102 and is introduced into the intracapillary space defined by the hollow fiber interior lumen within each of the liquid permeable hollow fiber filters 102. A permeate flow, which has passed through the walls of the liquid permeable hollow fiber filters 102, flows into a permeate outlet chamber 109 within the outlet end cap 108 on the outlet end 103 of the filter housing 104 of the filter device 100. A fluid outlet port 118 in fluid communication with the outlet end cap 108 receives a retentate flow from the outlet chamber 109.

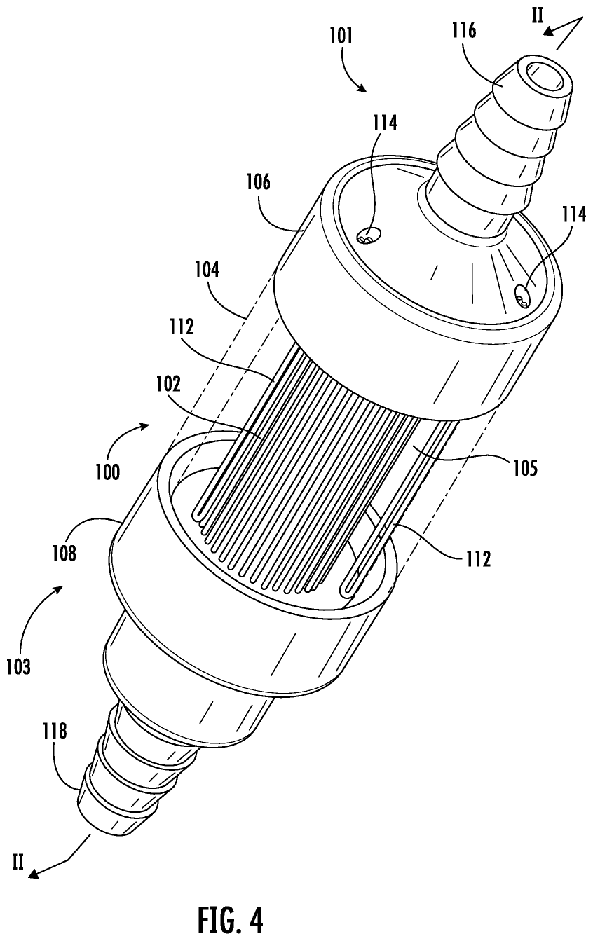

As the feedstream flow is introduced into the filter device housing 104, air and/or other gases (which may be referenced simply as air for the sake of convenience and without intent to limit) are also introduced. Such gases flow through the walls of the gas permeable hollow fiber filters 112 and into the intracapillary space defined by the hollow fiber interior lumen within each of the gas permeable hollow fiber filters 112. As may be appreciated with reference to FIG. 2, FIG. 3, and FIG. 4, the gas permeable hollow fiber filters 112 may be formed as loops with ends cut to expose intracapillary spaces defined by the lumens therein, similar to the liquid permeable hollow fiber filters 102. However, unlike the cut ends of the liquid permeable hollow fiber filters 102 which transfer permeate (within the lumen defined therein) further downstream in the filtration system in which the filter device 100 is used, the cut ends of the gas permeable hollow fiber filters 112 are exposed to the exterior of the filter device 100 and, optionally, the filtration system in general. In the example of an embodiment illustrated in FIGS. 1-4, the cut ends of the gas permeable hollow fiber filters 112 are exposed to the exterior of the filter device 100 via venting holes 114 defined within the inlet cap 106 to expose the intracapillary spaces defined by the lumens within the gas permeable hollow fiber filters 112 to the outside of the filter device 100. As such, venting of microbubbles from the feedstream out of filter device 100 and out of the filtration system in general is achieved. As may be appreciated, the cut ends of the gas permeable hollow fiber filters 112 may be potted within the end cap 106, 108 to be in fluid communication with a venting hole in such end cap 106, 108. It will be further appreciated that although the cut ends of the gas permeable hollow fiber filters 112 are illustrated as venting through vent holes 114 formed in the inlet end cap 106, the gas permeable hollow fiber filters 112 may, instead, vent through vent holes formed in the outlet end cap 108.

In accordance with various principles of the present disclosure, to prevent airlocking of the liquid permeable hollow fiber filters 102, it is generally desirable for the gas permeable hollow fiber filters 112 to access gases through the entire extracapillary space surrounding the exteriors of the liquid permeable hollow fiber filters 102 within the housing interior 105. For instance, it is generally desirable for the gas permeable hollow fiber filters 112 to extend along as much of the full length of the liquid permeable hollow fiber filters 102 as possible. In the example of an embodiment illustrated in FIG. 1, FIG. 2, FIG. 3, and FIG. 4, the closed ends of the loops of the gas permeable hollow fiber filters 112 extend in as close proximity to the downstream ends of the liquid permeable hollow fiber filters 102 (e.g., the cut ends in fluid communication with the outlet chamber 109) permitted by the techniques available to form the filter device 100, For instance, the gas permeable hollow fiber filters 112 extend substantially the entire length of the filter housing 104, such as all the way to the material in which the open ends of the liquid permeable hollow fiber filters 102 are potted. Any gas bubbles making contact with the exterior of the gas permeable hollow fiber filters 112 should go through the gas permeable hollow fiber filters 112 and be vented out of the filtration system.

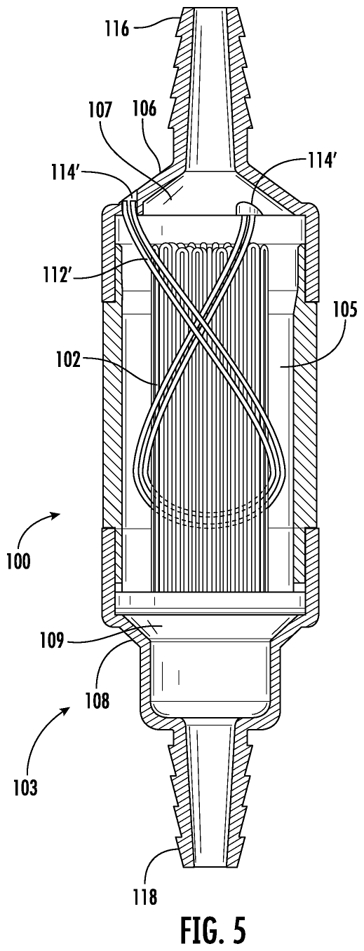

In some embodiments, such as illustrated in FIG. 5, the gas permeable hollow fiber filters 112′ coil around the liquid permeable hollow fiber filters 102. Such configuration increases the surface area of the liquid permeable hollow fiber filters 102 accessible by the gas permeable hollow fiber filters 112′ to facilitate venting of air accumulating along the exterior surfaces of the liquid permeable hollow fiber filters 102. Other features and aspects of the gas permeable hollow fiber filters 112′ are similar to the gas permeable hollow fiber filters 112 described above and reference is made thereto as applicable to the example of an embodiment illustrated in FIG. 5. Moreover, it will be appreciated that elements in FIG. 5 common to elements in FIGS. 1-4 are indicated with common reference numbers.

It will be appreciated that more than one gas permeable hollow fiber filter 112, 112′ may be used in a filter device 100 formed in accordance with various principles of the present disclosure. For instance, at least two or at least three gas permeable hollow fiber filters 112, 112′ may be used, with corresponding venting holes 114 in the inlet cap 106. The gas permeable hollow fiber filters 112 may be potted in the inlet cap 106 at substantially equal angular distances apart from one another. It will be appreciated that other configurations of hollow fiber filters than loops are within the scope of the present disclosure.

The foregoing discussion has broad application and has been presented for purposes of illustration and description and is not intended to limit the disclosure to the form or forms disclosed herein. It will be understood that various additions, modifications, and substitutions may be made to embodiments disclosed herein without departing from the concept, spirit, and scope of the present disclosure. In particular, it will be clear to those skilled in the art that principles of the present disclosure may be embodied in other forms, structures, arrangements, proportions, and with other elements, materials, and components, without departing from the concept, spirit, or scope, or characteristics thereof. For example, various features of the disclosure are grouped together in one or more aspects, embodiments, or configurations for the purpose of streamlining the disclosure. However, it should be understood that various features of the certain aspects, embodiments, or configurations of the disclosure may be combined in alternate aspects, embodiments, or configurations. While the disclosure is presented in terms of embodiments, it should be appreciated that the various separate features of the present subject matter need not all be present in order to achieve at least some of the desired characteristics and/or benefits of the present subject matter or such individual features. One skilled in the art will appreciate that the disclosure may be used with many modifications or modifications of structure, arrangement, proportions, materials, components, and otherwise, used in the practice of the disclosure, which are particularly adapted to specific environments and operative requirements without departing from the principles or spirit or scope of the present disclosure. For example, elements shown as integrally formed may be constructed of multiple parts or elements shown as multiple parts may be integrally formed, the operation of elements may be reversed or otherwise varied, the size or dimensions of the elements may be varied. Similarly, while operations or actions or procedures are described in a particular order, this should not be understood as requiring such particular order, or that all operations or actions or procedures are to be performed, to achieve desirable results. Additionally, other implementations are within the scope of the following claims. In some cases, the actions recited in the claims can be performed in a different order and still achieve desirable results. The presently disclosed embodiments are therefore to be considered in all respects as illustrative and not restrictive, the scope of the claimed subject matter being indicated by the appended claims, and not limited to the foregoing description or particular embodiments or arrangements described or illustrated herein. In view of the foregoing, individual features of any embodiment may be used and can be claimed separately or in combination with features of that embodiment or any other embodiment, the scope of the subject matter being indicated by the appended claims, and not limited to the foregoing description.

In the foregoing description and the following claims, the following will be appreciated. The phrases “at least one”, “one or more”, and “and/or”, as used herein, are open-ended expressions that are both conjunctive and disjunctive in operation. The terms “a”, “an”, “the”, “first”, “second”, etc., do not preclude a plurality. For example, the term “a” or “an” entity, as used herein, refers to one or more of that entity. As such, the terms “a” (or “an”), “one or more” and “at least one” can be used interchangeably herein. All directional references (e.g., proximal, distal, upper, lower, upward, downward, left, right, lateral, longitudinal, front, back, top, bottom, above, below, vertical, horizontal, radial, axial, clockwise, counterclockwise, and/or the like) are only used for identification purposes to aid the reader's understanding of the present disclosure, and/or serve to distinguish regions of the associated elements from one another, and do not limit the associated element, particularly as to the position, orientation, or use of this disclosure. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. Identification references (e.g., primary, secondary, first, second, third, fourth, etc.) are not intended to connote importance or priority, but are used to distinguish one feature from another.

The following claims are hereby incorporated into this Detailed Description by this reference, with each claim standing on its own as a separate embodiment of the present disclosure. In the claims, the term “comprises/comprising” does not exclude the presence of other elements, components, features, regions, integers, steps, operations, etc. Additionally, although individual features may be included in different claims, these may possibly advantageously be combined, and the inclusion in different claims does not imply that a combination of features is not feasible and/or advantageous. In addition, singular references do not exclude a plurality. Reference signs in the claims are provided merely as a clarifying example and shall not be construed as limiting the scope of the claims in any way.

What is claimed is:

1. A filter device comprising:
a housing with an inlet chamber defined at an inlet end of the housing, and an outlet chamber defined at an outlet end of the housing and fluidly sealed from the inlet chamber;
at least one liquid permeable hollow fiber filter disposed within the filter housing, the liquid permeable hollow fiber filter having a liquid permeable wall defining a lumen extending through the liquid permeable hollow fiber filter and defining an intracapillary space in fluid communication with the outlet chamber, the exterior surface of the liquid permeable side wall being in fluid communicates with the inlet chamber via extracapillary space defined within the interior of the housing; and
at least one gas permeable hollow fiber filter disposed within the filter housing, the gas permeable hollow fiber filter having a gas permeable sidewall defining a lumen extending through the gas permeable hollow fiber filter and defining an intracapillary space in fluid communication with the exterior of the housing to vent gases to outside the filter device, the exterior surface of the gas permeable side wall being in fluid communication with the inlet chamber via the extracapillary spaced defined by the interior of the housing.

2. The device of claim 1, further comprising:
an inlet end cap coupled to the inlet end of the housing and defining the inlet chamber therein; and
an outlet end cap coupled to the outlet end of the housing and defining the outlet chamber therein;
wherein the gas permeable hollow fiber filter has at least one open end extending through one of the end caps to be in fluid communication with the exterior of the end cap.

3. The device of claim 2, wherein the gas permeable hollow fiber filter is in the form of a loop with a closed end and two open ends, the closed end being disposed within the housing and the open ends being in fluid communication with the exterior of the housing.

4. The device of claim 3, wherein the liquid permeable hollow fiber filter is in the form of a loop with a closed end and two open ends, the two open ends being potted in the outlet end cap.

5. The device of claim 2, wherein the liquid permeable hollow fiber filter is in the form of a loop with a closed end and two open ends, the two open ends being potted in the outlet end cap.

6. The device of claim 1, wherein the gas permeable hollow fiber filter is formed of polypropylene.

7. The device of claim 1, wherein the at least one gas permeable hollow fiber filter extends from the inlet end of the housing to the outlet end of the housing.

8. The device of claim 7, wherein the at least one liquid permeable hollow fiber filter has an end in fluid communication with the outlet chamber and sealed from the interior of the housing.

9. A filter device comprising:
a housing defining an interior therein;
a liquid permeable hollow fiber filter having a wall with an exterior in fluid communication with the interior of the housing and defining a lumen within the liquid permeable hollow fiber filter in fluid communication with an outlet chamber fluidly sealed from the housing interior; and
a gas permeable hollow fiber filter with a wall having an exterior in fluid communication with the interior of the housing and defining a lumen within the gas permeable hollow fiber filter venting to outside the housing to release gas passing through the wall of the gas permeable hollow fiber filter from the interior of the housing to the lumen within the gas permeable hollow fiber filter.

10. The device of claim 9, further comprising:
an inlet end cap coupled to an inlet end of the housing and defining an inlet chamber therein; and
an outlet end cap coupled to an outlet end of the housing and defining an outlet chamber therein;
wherein the gas permeable hollow fiber filter has at least one open end extending through one of the end caps to be in fluid communication with the exterior of the end cap.

11. The device of claim 10, wherein the gas permeable hollow fiber filter is in the form of a loop with a closed end and two open ends, the closed end being disposed within the housing and the open ends being in fluid communication with the exterior of the housing.

12. The device of claim 11, wherein the liquid permeable hollow fiber filter is in the form of a loop with a closed end and two open ends, the two open ends being potted in the outlet end cap.

13. The device of claim 10, wherein the liquid permeable hollow fiber filter is in the form of a loop with a closed end and two open ends, the two open ends being potted int the outlet end cap.

14. The device of claim 9, wherein the at least one gas permeable hollow fiber filter extends substantially along the entire length of the at least one liquid permeable hollow fiber filter.

15. A method of venting a filtration system, the method comprising:
passing a feedstream through an inlet of a filter device and into the interior of the housing of the filter device;
allowing the feedstream to filter through the wall of a liquid permeable hollow fiber filter within the filter housing from the exterior surface of the wall of the liquid permeable hollow fiber filter and into a lumen defined within the liquid permeable hollow fiber filter;
passing gas from the interior of the filter housing through the wall of a gas permeable hollow fiber filter disposed within the filter housing, from the exterior surface of the gas permeable hollow filter fiber wall and into a lumen defined within the gas permeable hollow fiber filter; and
venting gas from within the gas permeable hollow fiber filter lumen to be expelled out an open end of the gas permeable hollow fiber filter communicating with the exterior of the housing.

16. The method of claim 15, further comprising allowing the gas permeable hollow fiber filter to continuously vent the filter device by allowing gas to escape out of the filter housing.

17. The method of claim 15, further comprising collecting the permeate within the liquid permeable hollow fiber filter lumen through an outlet of the filter device.
